(19) United States
(12) Patent Application Publication
(10) Pub. No.: US 2006/0175300 A1
(43) Pub. Date: Aug. 10, 2006

(54) Structure of laser-engraving machine

(75) Inventor: Jin-Sheng Lai, Hsi Chih City (TW)

Correspondence Address: LOWE HAUPTMAN BERNER, LLP, 1700 DIAGONAL ROAD, SUITE 300, ALEXANDRIA, VA, 22314, US

(73) Assignee: GREAT COMPUTER CORPORATION

(21) Appl. No.: 11/053,413

(22) Filed: Feb. 9, 2005

(51) Int. Cl. B23K 26/00

(52) U.S. Cl. 219/121.6

(57) ABSTRACT

A structure of laser-engraving machine comprising a main body, wherein the main body has a plurality of chests adapted to connecting with each other, each chest has independent modules, assembling of the chests thus forms the structure of laser-engraving machine, separation of the chests renders convenience of repairing, maintenance or changing for module systems.

### BACKGROUND OF THE INVENTION

1. Field of the Invention

The present invention relates to a structure of laser-engraving machine, and in particular to a structure of laser-engraving machine having in its main body a plurality of chests capable of connecting with each other, hence in repairing, assembling, maintenance or changing of module systems of the machine, the chests can be separated, this can increase changeability and convenience of the machine.

2. Description of the Prior Art

Laser-cutting/engraving technique is a fast developing and widely used brand-new processing technique in the present time; it has the advantages of wide adaptability, high processing preciseness, being not-causing-damage to work pieces to be processed, being easy to control, reliability, high efficiency of processing and good engraving quality.

A laser-engraving machine “A” available in the markets presently has a machine body A1 with a working platform thereon, the platform is provided thereon with a laser output head driven by a polar axis; an outer hood of the working platform has an upper housing A2 (as shown in FIG. 1), the upper housing A2 has on its four sides holes for screwing in of screws to fix on the machine body A1; the machine body A1 has therein a gearing system, a module in coindidence with that of an upper cover, and various modules of different systems. The weight of the entire machine after assembling is very heavy. Additionally, by virtue that each machine is independently processed by a single factory from its production to finishing of the product, it needs to be provided with modules of complicated and a great number of specifications, therefore, it is very cumbersome and time consuming in production, and is subject to having the problem of wrongly connecting. Moreover, when it is desired to change systems of modules or to repair and maintain, the upper housing A2 shall be detached in the first place, and then the entire machine body A1 can be detached for working; thereby the members shall be reassembled also in a cumbersome mode after removing the fault before testing and normal working, this not only causes inconvenience of use, but also renders the processes of detaching and assembling quite time and power consuming.

In view of the above stated, the inventor of the present invention studied hard to develop the laser-engraving machine of the present invention that can solve the problem resided in the existing technique.

### SUMMARY OF THE INVENTION

The primary objective of the present invention is to provide a structure of laser-engraving machine having in its main body a plurality of chests capable of connecting with each other, hence in repairing, assembling, maintenance or changing of module systems of the machine, the chests can be separated; this can increase changeability and convenience of the machine.

Another objective of the present invention is to provide a structure of laser-engraving machine having a plurality of chest modules capable of separately assembled in layers and then connected to form a whole machine, this can speed up finishing of the product.

To achieve the above objectives, the structure of laser-engraving machine of the present invention comprises a main body being improved in that: the main body has a plurality of chests capable of mutually connecting, each chest has independent modules, assembling of the chests can thus form the structure of laser-engraving machine, separation of the chests can be convenient for repairing, maintenance or changing of module systems of the machine.

The present invention will be apparent after reading the detailed description of the preferred embodiment thereof in reference to the accompanying drawings.

### BRIEF DESCRIPTION OF THE DRAWINGS

FIG. 1 is an exploded perspective view showing the appearance of a conventional laser-engraving machine;

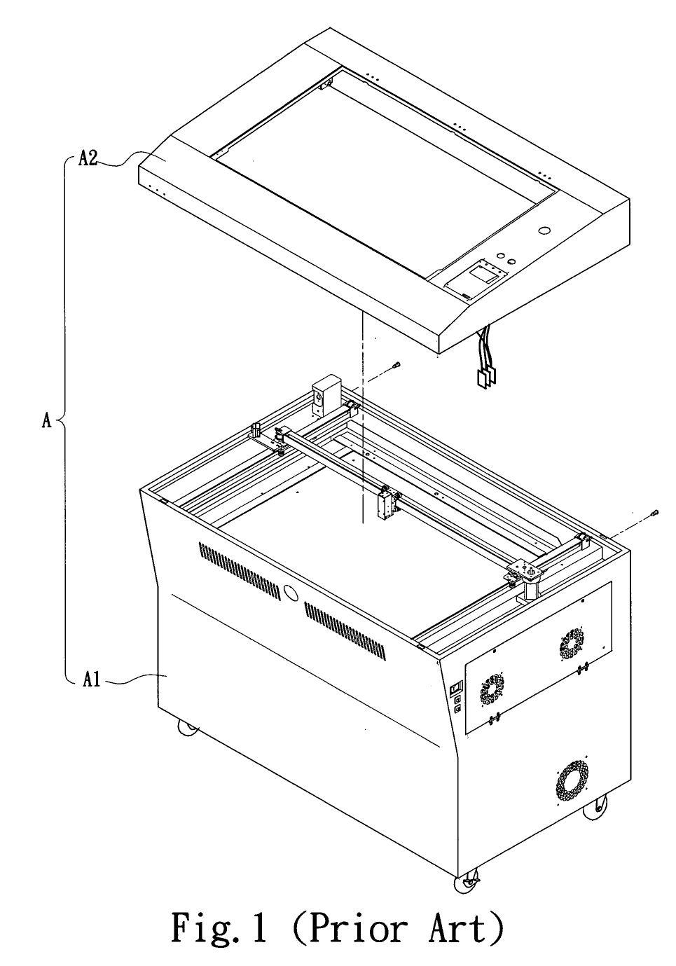

FIG. 2 is an exploded perspective view showing the appearance of an embodiment of the present invention;

FIG. 3 is a schematic view showing the state before connecting of an upper cover with a main body of the machine of the embodiment of the present invention;

FIG. 4 is a perspective view showing the appearance of the embodiment of the laser-engraving machine of the present invention after connecting;

FIG. 5 is a schematic perspective view showing application of the embodiment of the present invention.

### DETAILED DESCRIPTION OF THE PREFERRED EMBODIMENT

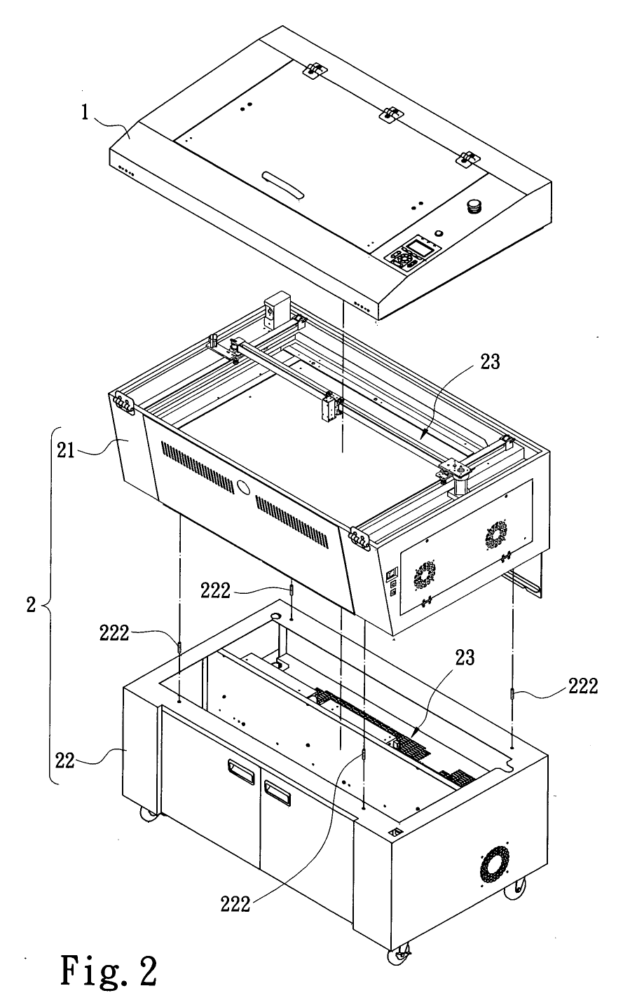

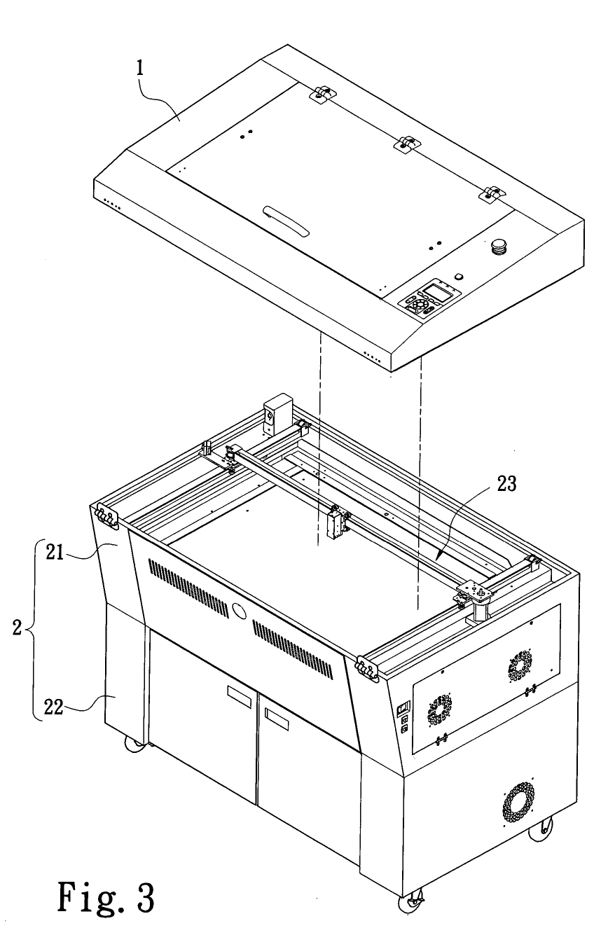

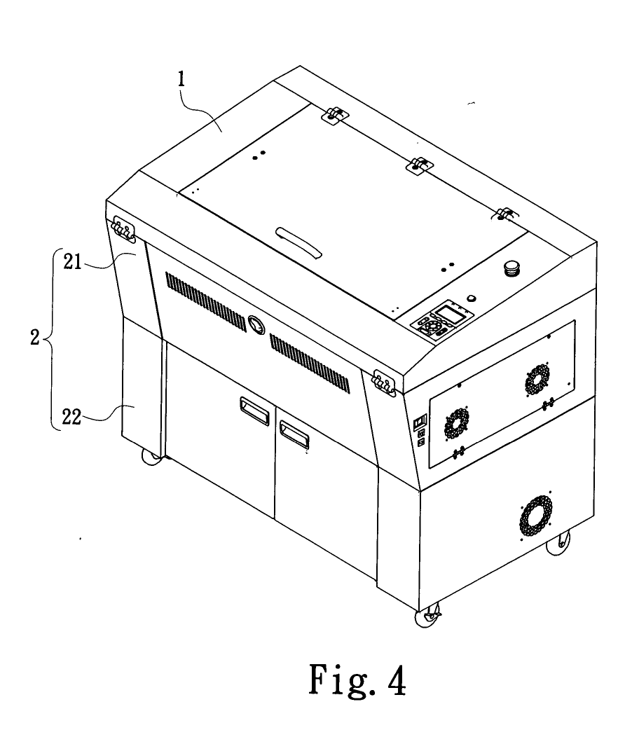

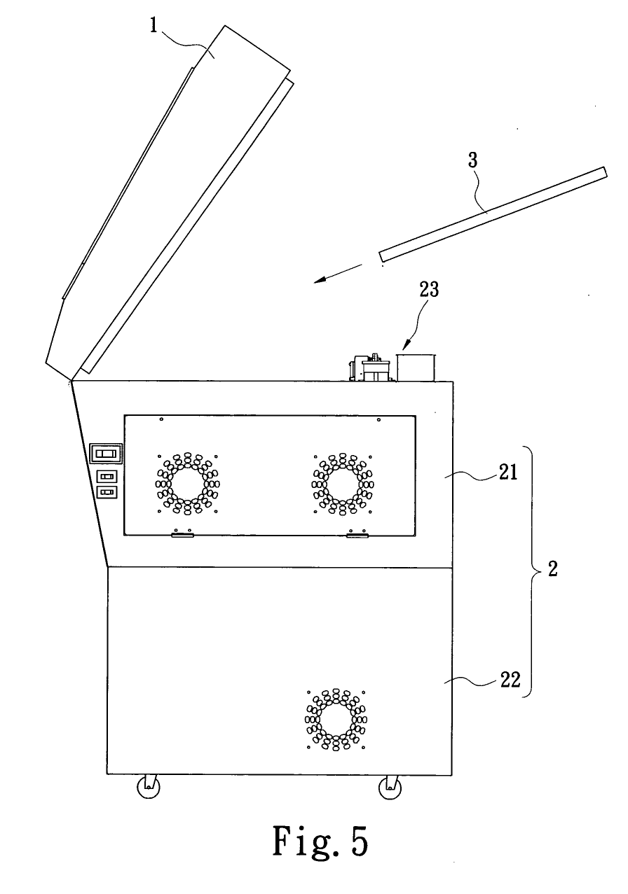

Referring firstly to FIGS. 2-5 showing the structure of an embodiment of the laser-engraving machine of the present invention, the structure comprises an upper cover 1 and a main body 2.

The upper cover 1 is pivotally connected with an upper area of the main body 2, in order that one side of the upper cover 1 can be lifted from the main body 2.

The main body 2 has a plurality of chests capable of connecting mutually; taking the embodiment having a first chest 21 and a second chest 22 for description, the first and the second chests 21, 22 have independently processed modules, every of the first chest 21, the upper cover 1 and the second chest 22 is for placing therein module systems 23 (such as laser modules and electric power modules) of a specific specification, and the two chests 21, 22 are mutually lapped and connected using fixing members 222, the fixing members 222 are screws, thereby when the main body 2 is repaired, maintained or changed for other module systems, the two chests 21, 22 can be separated just by detaching the fixing members 222.

When in practicing, referring again to FIGS. 2-5, in the first place, the second chest 22 having a module system 23 is connected with the first chest 21 with the fixing members 222 in pursuance of requirement of operation, and the upper cover 1 is pivotally connected with an upper area of the main body 2 to complete assembling of the laser-engraving machine. When it is desired to use or change for other module systems 23, it needs only to separate the first chest 21 from the second chest 22, and to change for or add the module systems 23 that a user requires, and changing of specification can thus be completed. Then just lift the upper cover 1, and carving operation of a work piece 3 can be performed (as shown in FIG. 6).

Additionally, when user releases one side of the upper cover 1, he can thus pull at the rear side of the upper cover 1 to lift the latter for repairing or maintenance.

Therefore, the present invention has the following advantages:
1. The main body of the laser-engraving machine of the present invention is designed to be separable, so that a user needs only to separate the two mutually connected chests for changing with or adding chests having required module systems, thus the changing of specification can thus be completed. This is convenient for changing and assembling module systems of the products to reduce working hours.
2. The upper cover and each chest of the laser-engraving machine of the present invention are connected mutually. It is convenient for repairing and maintenance because it does not need to detach the entire machine.

In conclusion, the present invention surely can get the expected object thereof to provide a laser-engraving machine, it is extremely practical and has a value of utility, having thus described my invention with practical value, what I claim as new and desire to be secured by Letters Patent of the United States is:

1. A structure of laser-engraving machine comprising a main body, the improvement in that:
said main body has a plurality of chests adapted to connecting with each other, each of said chests has independent modules, assembling of said chests thus forms said structure of laser-engraving machine, separation of said chests renders convenience of repairing, maintenance or changing for module systems.

2. The structure of laser-engraving machine as in claim 1, wherein: said chests are mutually connected using fixing members.

3. The structure of laser-engraving machine as in claim 2, wherein: said fixing members are screws.

4. The structure of laser-engraving machine as in claim 1, wherein: an upper cover is pivotally connected with an upper area of said main body, in order that one side of said upper cover is adapted to lifting from said main body.

5. The structure of laser-engraving machine as in claim 1, wherein: said chests are mutually connected by lapping.
